(19) United States
(12) Patent Application Publication
(10) Pub. No.: US 2024/0009077 A1
(43) Pub. Date: Jan. 11, 2024

(54) ARRANGEMENT FOR SERVING BEVERAGE PACKAGINGS

(71) Applicant: Sbar Oy, Riihimäki (FI)

(72) Inventor: Pekka SALMI, Riihimäki (FI)

(73) Assignee: Sbar Oy, Riihimäki (FI)

(21) Appl. No.: 18/252,390

(22) PCT Filed: Oct. 21, 2021
(86) PCT No.: PCT/FI2021/050707

§ 371 Date: May 10, 2023

Related U.S. Application Data
(60) Provisional application No. 63/112,198, filed on Nov. 11, 2020.

(51) Int. Cl. A61H 33/06; A47F 1/06

(52) U.S. Cl. CPC A61H 33/067; A47F 1/06

(57) ABSTRACT

The invention relates to an arrangement for serving beverage packagings (10), the arrangement comprising at least a storage chamber (120) for storing beverage packagings (10), a support element (210) with an upper surface, and a lifting unit (110) for lifting beverage packagings from the storage chamber. The lifting unit has an upper position and a lower position, wherein the lifting unit (110) is adapted to be lifted between said upper and lower positions manually by the user of the arrangement (100). The lifting unit (110) is arranged to lift a beverage packaging (10) from the storage chamber (120) onto said upper surface of the support element (210) when the lifting unit (110) is lifted from said lower position into said upper position. The lifting unit (110) has an inclined surface top (112) which is adapted to receive a beverage packaging (10) from said storage chamber (120) when the lifting unit (110) is in said lower position, wherein the beverage packaging (10) on said inclined surface top (112) is able to roll, driven by the inclination of said inclined surface top, onto the upper surface of the support element (210) when the lifting unit is in said upper position. The arrangement (100) includes a front wall (111) extending downwards from the inclined surface top (112) of the lifting unit, the front wall being dimensioned to extend, when the lifting unit (110) is in the lifted-up position, at least partially in front of the beverage packagings (10) in the storage chamber (120), forming a retainer part to retain the beverage packagings (10) in place in the storage chamber (120), until the lifting unit (110) is lowered back down into the position receiving a beverage packaging.

This application is a U.S. national stage filing under 35 U.S.C. § 371 of International Application No. PCT/FI2021/050707, filed 21 Oct. 2021, which claims the benefit of priority of U.S. Provisional Application No. 63/112,198, filed 11 Nov. 2020, all of which are incorporated herein by reference in their entirety.

### FIELD OF THE INVENTION

The invention relates to an arrangement for serving beverage packagings according to the preamble of claim 1.

Such an arrangement is disclosed in the earlier Finnish utility model registration no. 12579 held by the applicant of the present application.

Storing and serving cold beverages in a sauna is difficult. The steam room is hot and moist, thus solutions based on a refrigerator or the like are not optimal be-cause a refrigerator has difficulty implementing cooling if the cooling fin is located in a hot sauna. Humidity and water also create difficulties and, in practice, will prevent a refrigerator from being placed in a steam room. Typically, a refrigerator or other cold storage equipment is indeed located outside of the steam room, such as, for example, in a dressing room. Refrigerator doors or other visible technology are also not suitable for the appearance and ambiance of a steam room.

Utility model registration no. 12579 related to an arrangement with which bever-age packagings can be stored cold even in a sauna, which is well hidden in the general appearance of the sauna, and which does not require complicated technology or electricity to function. The aim was to provide a simple storage and serving device for beverage packagings to be integrated into the furnishings. When installed into the benches of a sauna, the device functions as a beverage packagings cold space, from which a beverage packaging can be removed while sitting on the benches. The arrangement functions as an integrated cold storage space, for example, in the benches of a sauna, or in the other furnishings of the sauna. It is also suitable for use in the furnishings and worktops of other spaces, such as, for example, in tables, worktops and serving counters, or benches. Said arrangement comprises at least a storage chamber for storing beverage packagings, a support element with an upper surface, and a lifting unit for lifting beverage packagings from the storage chamber, the lifting unit having an upper position and a lower position, in which the lifting unit is adapted to be lifted and lowered between said upper and lower positions manually by the user of the arrangement, wherein the lifting unit is arranged to lift a beverage packaging from the storage chamber onto said upper surface of the support element when the lifting unit is lifted from said lower position into said upper position.

FIG. 1 illustrates an arrangement 100 for serving beverage packagings according to an embodiment known from the utility model registration no. 12579. FIG. 1 shows a simplified cross-sectional view of such an arrangement. FIG. 1 shows the lifting unit 110, the storage chamber 120 for beverage packagings, and a surface top 50 into which the arrangement 100 is installed. The surface top 50 may be, for example, a tabletop, bench, or a bench element of a sauna. FIG. 1 also shows beverage packagings 10 placed into the storage chamber 120. FIG. 1 also shows the inclined lower surface 122 of the storage chamber 120 and the inclined surface top 112 of the lifting unit which are described in more detail below.

In this embodiment, the inclination of the lower surface 122 causes the beverage packagings to roll towards the lifting unit 110, wherein, in this embodiment, the feeding of the beverage packagings into the lifting unit occurs by gravity. In various embodiments of the invention, the feeding may be implemented in various ways, for example, driven by a spring, wherein the beverage packagings do not need to be round and rollable.

In this embodiment, the lifting unit 110 is arranged to be lifted manually but, in various embodiments, the lifting unit can be arranged to be lifted by other structures, such as by motor power, compressed air, or in other ways.

FIG. 1 does not illustrate more precisely how the beverage packagings 10 can be placed into the storage chamber 120, as it is obvious to a person skilled in the art that this may be implemented in many different ways. The beverage packagings may be placed inside the arrangement, for example, from the end or from the top of the device, from the side, or from a site separately built into it for this purpose. There may be one or several beverage packagings. The arrangement may be implemented for beverage amounts of various sizes. A beverage pack-aging may vary in both in its volume and in its shape. The beverage packaging may be, for example, a can or a bottle.

Preferably, the storage chamber 120 may be implemented from thermal insulation material, or be covered with such a material, wherein cold beverage packagings will remain cold for a long time without a need for separate cooling, even if the arrangement were to be installed into a hot steam room.

FIG. 2A shows the initial step of lifting a beverage packaging to be served. In comparison to FIG. 1, the beverage packagings 10 have rolled towards the lifting unit 110, and one of the beverage packagings has rolled onto the inclined surface 112 of the lifting unit 110. FIG. 2A shows a situation, in which the lifting unit has already risen somewhat from its lower position. FIG. 2 also shows the support element 210 which, in this embodiment, is surrounded by the lifting unit 110. In this embodiment, the support element guides the movement of the lifting unit and supports it, and also functions as a tray for the beverage packaging that has been lifted to be served. In this embodiment, the upper surface of the support element is preferably substantially flush with the upper surface of the surface top 50 of the furniture.

In FIG. 2B, the lifting unit 110 is lifted into its upper position, wherein the bever-age packaging 10 is substantially at the height of the upper surface of the surface top 50. In the situation of FIG. 2B, the beverage packaging 10 is able, driven by the inclination of the inclined surface 112, to roll onto the support element 210. The rolling of a beverage can can be stopped on the support element 210, for example, by the rear wall of the lifting unit 110, or by another similar barrier, in order that the beverage packaging does not roll past the support element. For the sake of clarity, such a rear wall is not shown in FIG. 2B.

FIG. 2C shows a final situation, in which the lifting unit 110 is lowered back into its lower position, and the beverage packaging 10 has remained lying on the support element 210.

FIG. 3 illustrates the gripping elements 310 of the lifting unit 110 according to one embodiment. In this example, the gripping elements are holes 310, through which the user can grasp with his/her fingers. In this embodiment, the gripping elements are on different sides of the upper surface of the support element 210, wherein, in the final lifting situation when the lifting unit is lowered down, the beverage packaging lifted to be served remains between the fingers of the user, wherein it is easy to pick it from there.

In such an embodiment, removing a beverage packaging from the storage chamber of the arrangement is very easy: the user just takes hold of the gripping elements of the lifting unit, lifts the lifting unit up, lowers it back down, and grasps onto the beverage packaging which has been lifted up between his/her fingers.

In various embodiments, the gripping elements 310 may also be other kinds of elements than holes. For example, the gripping elements may be indentations, or small handles.

The visible upper surfaces of the lifting unit, the support element and the storage chamber may be implemented in various embodiments using different materials. For example, in such an embodiment, in which the arrangement is adapted to be installed into the benches of a sauna, these visible upper surfaces may be implemented from the wood used for benches.

FIGS. 4A-4F illustrate the function of an arrangement according to one known embodiment.

FIG. 4A illustrates the initial situation, in which the lifting unit 110 is in its lower position, and there are beverage packagings 10 in the storage chamber 120.

FIG. 4B illustrates a situation, in which the beverage packagings have rolled to-wards the lifting unit 110 driven by the inclined lower surface 122 of the storage chamber, and one of the beverage packagings 10 lies on the inclined surface 112 of the lifting unit.

FIG. 4C illustrates a situation, in which the lifting unit 110 is lifted into its upper position, wherein the beverage packaging 10 on top of the inclined surface 112 of the lifting unit has been lifted up from the storage chamber.

FIG. 4D illustrates a situation, in which the beverage packaging 10 that was on top of the inclined surface 112 of the lifting unit has rolled onto the support element driven by the inclination of the inclined surface 112.

FIGS. 4E and 4F illustrate a situation, in which the lifting unit 110 is lowered back into its lower position. FIG. 4E illustrates the situation from the lateral direction, and is illustrating how a beverage packaging that has been lifted to be served is targeted directly into the hand of the user. FIG. 4F illustrates the same situation from a perspective view. By repeating the steps of FIGS. 4A-4F, the user can easily lift one or more, or even all of the beverage packagings from the storage chamber.

In the following, some exemplary embodiments are described. A first aspect implements an arrangement for serving beverage packagings. In a first embodiment of this first aspect, the arrangement comprises at least a storage chamber for storing beverage packagings, a support element with an upper surface, and a lifting unit for lifting beverage packagings from the storage chamber, the lifting unit having an upper position and a lower position; wherein the lifting unit is adapted to be lifted and lowered between said upper and lower positions manually by the user of the arrangement, wherein the lifting unit is arranged to lift a beverage packaging from the storage chamber onto said upper surface of the support element when the lifting unit is lifted from said lower position into said upper position.

In another embodiment of this first aspect, said lifting unit has an inclined surface top which is adapted to receive a beverage packaging from said storage chamber when the lifting unit is in said lower position, and the beverage packaging on said inclined surface top is able to roll, driven by the inclination of said surface top, onto the upper surface of the support element when the lifting unit is in said up-per position.

In another embodiment of this first aspect, said lifting unit comprises gripping elements which are arranged such that, as the user takes hold of the gripping elements of the lifting unit in order to lift the lifting unit from the lower position into the upper position, the upper surface of said support element remains at least partially between the thumb and the other fingers of the user.

According to a second aspect, the arrangement is implemented as a piece of furniture, into which is integrated an arrangement according to said first aspect. According to a third aspect, the arrangement is implemented as a bench element for the benches of a sauna, into which bench element is integrated an arrangement according to said first aspect.

### SUMMARY

The object of the present invention is to provide an improved storage and serving device for beverage packagings to be installed into furnishings.

This improved arrangement is characterised by the characterizing features dis-closed in the characterizing part of independent claim 1. The arrangement includes, extending downwards from the inclined surface top of the lifting unit, a front wall which is dimensioned to extend, when the lifting unit is in the lifted-up position, at least partially in front of the beverage packagings in the storage chamber, forming a retainer part to retain the beverage packagings in place in the storage chamber, until the lifting unit is lowered back down into the position receiving a beverage packaging. A solution according to the invention is further characterised by providing the frame part of the device with quick fastening elements by means of which a separate casing containing a storage chamber for beverage packagings can be quickly and easily fastened to an application site and removed from it for cleaning the casing as needed. Preferably, the casing is pro-vided in the area of its upper edge with longitudinal discharge grooves, especially when used in a sauna, in order to guide sweat and possible wash water trickling down from persons using the sauna away from the joint seam between the casing and its cover.

### BRIEF DESCRIPTION OF THE DRAWINGS

Various embodiments of the invention are illustrated in the accompanying figures, in which:

FIG. 1 illustrates an arrangement according to prior art,

FIGS. 2A, 2B and 2C illustrate the function of a known arrangement,

FIG. 3 illustrates the gripping elements 310 of the lifting unit according to a known arrangement,

FIGS. 4A-4F illustrate the function of a known arrangement,

FIG. 5 shows the frame part of a device according to the present invention as a schematic perspective view as seen from below,

FIG. 6 shows the casing to be fastened to a frame part according to FIG. 5 as a schematic perspective view as seen from above,

FIG. 7 shows the cover part of a casing according to FIG. 6,

FIG. 8 shows as a schematic longitudinal sectional view a part of the casing and the lifting unit when the lifting unit is in the lowered-down position,

FIG. 9 shows a view corresponding to FIG. 8 when the lifting unit is in the lifted-up position,

FIG. 10 shows the lifting unit in the lifted-up position as a schematic perspective view,

FIG. 11 shows a second embodiment of the casing, and

FIG. 12 shows a detail of the fastening of the casing.

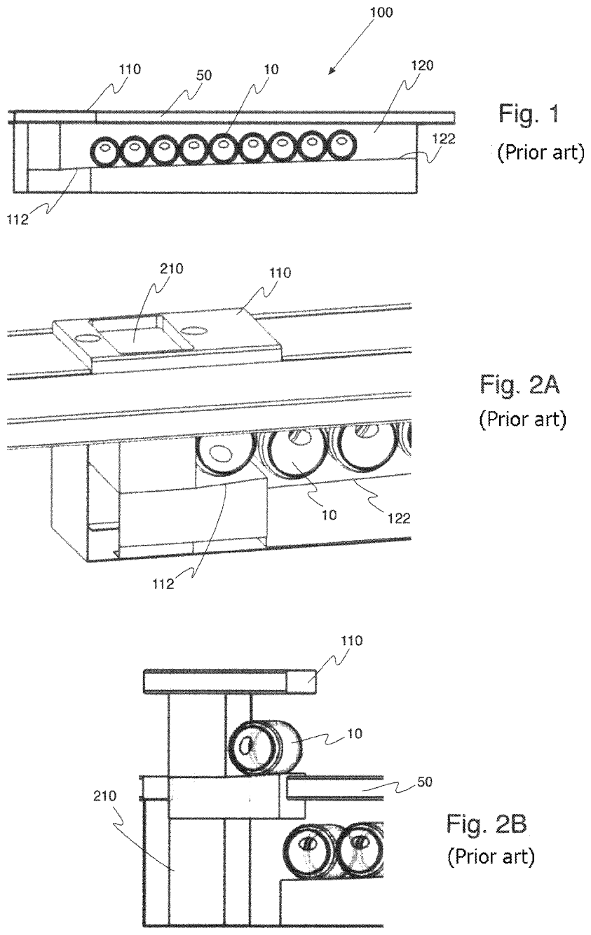

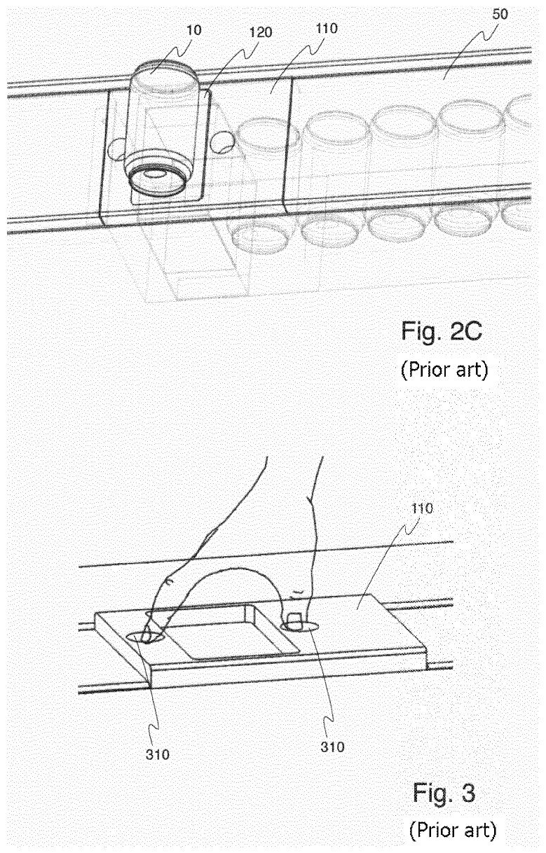

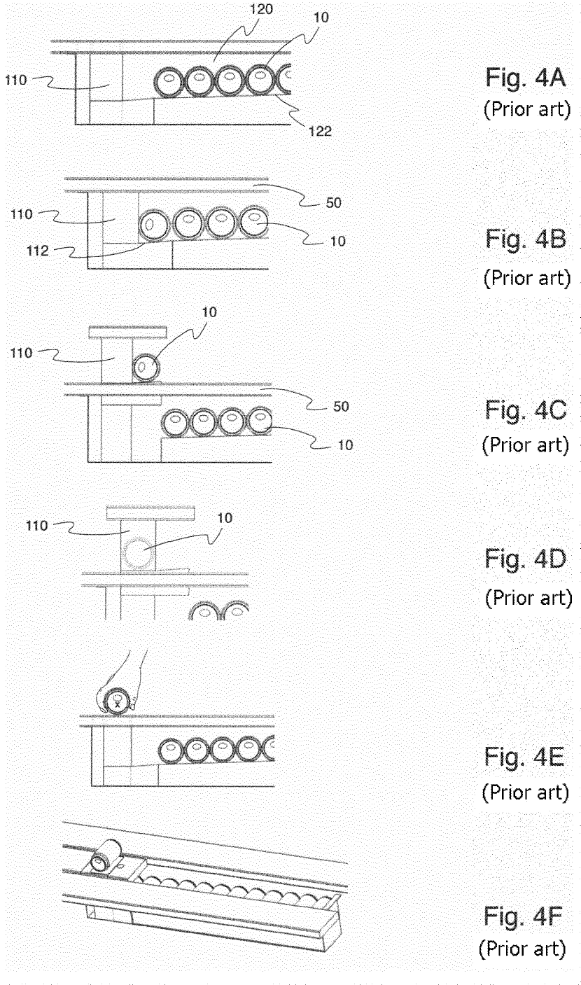

### DETAILED DESCRIPTION OF THE EXEMPLARY EMBODIMENTS

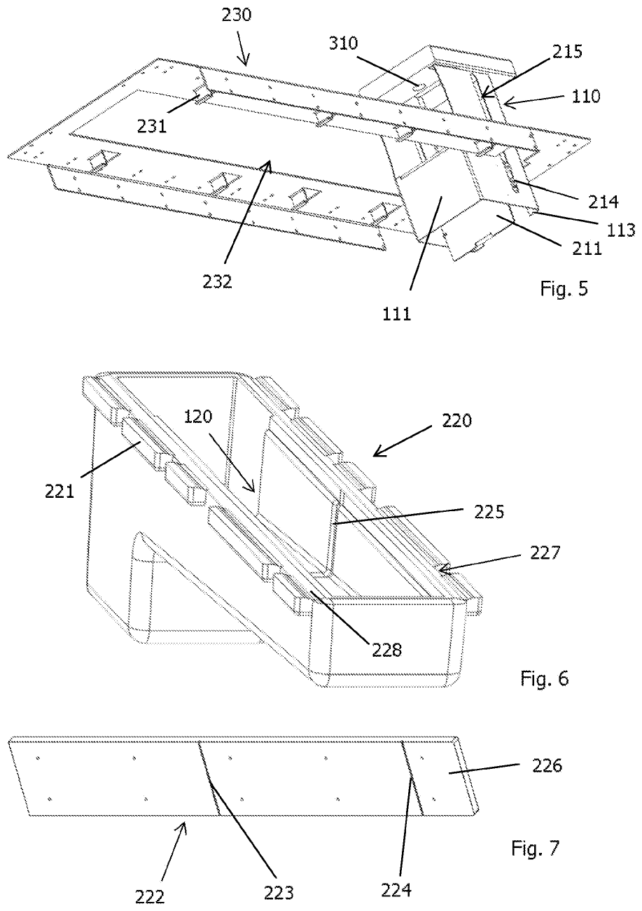

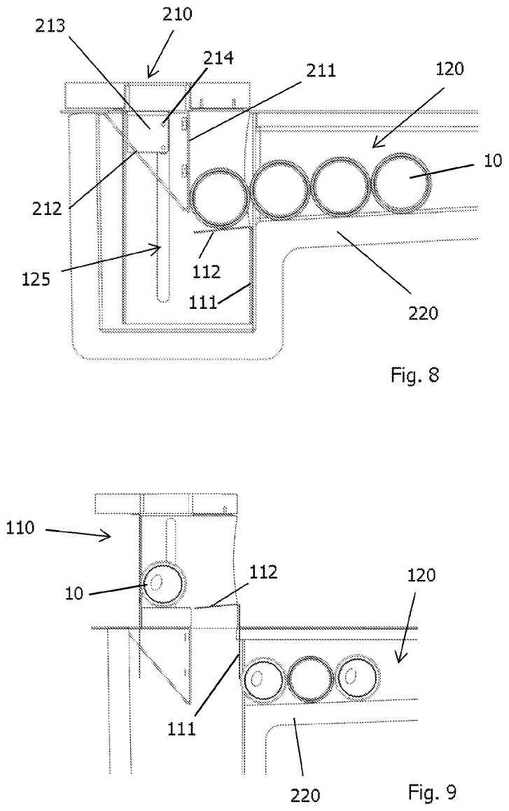

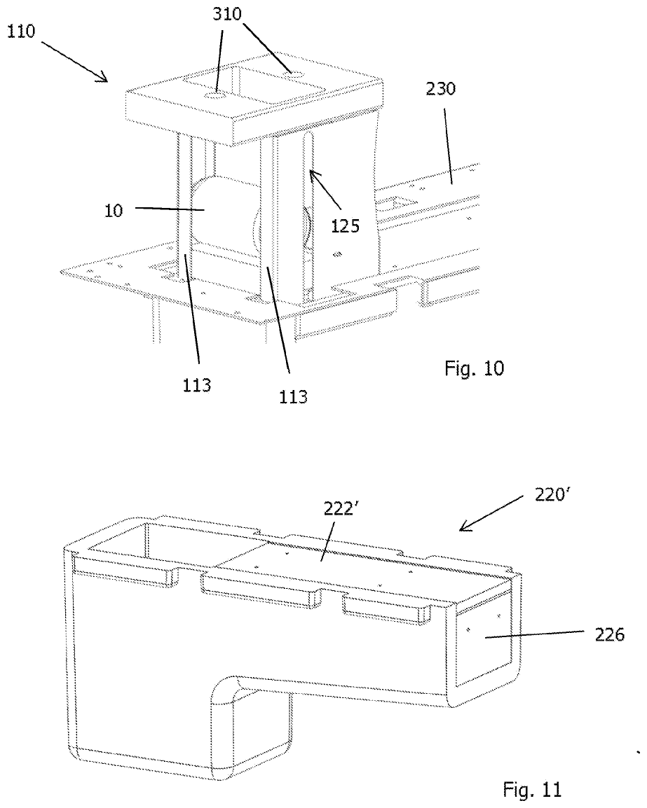

An improved storage and serving device for beverage packagings according to the invention is disclosed with reference to FIGS. 5-12.

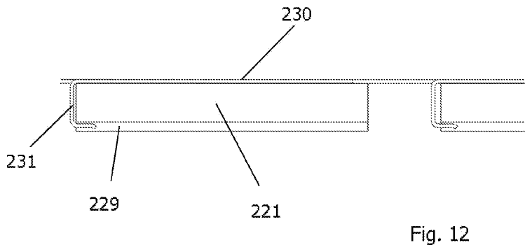

FIG. 5 shows as a schematic perspective view the metallic frame part 230 of a device according to the invention which is intended to be fastened to the lower surface of a piece of furniture, such as a bench or table, or, for example, the lower surface of a sauna bench. On the frame part are formed fastenings 231 cut and bent from a metal sheet, supported by which fastenings, for example, the casing 220 shown in FIG. 6 containing the storage chamber 120 can be installed with the fastening parts 221. The fastening parts 221 contain a recess 222, into which the substantially horizontally bent outermost head of the fastening 231 is to be inserted by the horizontal movement of the casing 220. FIG. 12 shows schematically the fastening part 221 of the casing 220, into the recess 229 of which the fastening 231 of the frame part 230 has settled. This solution enables easy fastening of the casing 220 to the frame part. The casing is also easily re-movable from the frame part, for example, for cleaning it.

The lifting unit 110 is arranged into the frame part to move substantially vertically between the lowered-down position receiving a beverage packaging and the lift-ed-up position dispensing a beverage packaging. In the receiving position, the lifting unit 110 receives a beverage packaging 10 onto the inclined surface 112 of the lifting unit as the beverage packagings move by gravity along the inclined lower surface 122 of the storage chamber 120 of the casing 220 sloping down towards the lifting unit. The lifting unit surrounds the support element 210 which includes a downwards-oriented front edge 211 which forms a stop element to the beverage packaging 10 which has moved onto the inclined surface 112 of the lifting unit 110, preventing it from moving away from the surface 112. From the downwards-oriented portion departs diagonally upwards, extending in the direction facing away from the storage chamber, a diagonal brace 212 which is connected to the frame part 230. Further, to the support element 210, on its opposing sides, are connected plate parts 213, to which are fastened support rollers 214 which settle into the vertical grooves 125 formed to the opposite sides of the lifting unit, guiding the lifting unit 110 while it is moving between its receiving position and its dispensing position. In a solution according to the invention, the front wall 111 extending downwards from the inclined surface 112 of the lifting unit 110 is extended such that, when the lifting unit is in the upper position, the lower edge of the front wall 111 extends, according to that shown in FIG. 9, at least partially in front of the beverage packagings 10 in the storage chamber 120, preventing them from rolling into the space below the lifted-up lifting unit 110. This forms a simple solution for keeping the beverage packagings in the storage chamber, until the lifting unit is lowered back down to the position receiving beverage packagings.

As the lifting unit is lifted into its upper position, a can on its inclined surface 112 is able to roll by gravity onto the upper surface of the support element 210. To the rear edge of the lifting unit are preferably formed corner bends 113 which stop a beverage packaging 10 on the upper surface of the support element, from which it is easily lifted away when the lifting unit returns to its lowered-down position.

FIG. 6 shows schematically one casing solution 220 which is provided with a cut-off groove 225, enabling at the same time that the casing can be cut off for a smaller amount of beverage packagings. FIG. 11 shows schematically such a shortened casing 220′. The casing 221′ is closed at its end by means of an end piece 226. The casing 220′ can be closed from above by a cover part 222′ which is obtained from the cover 222 made for the longer casing 220 shown in FIG. 7 which is to be cut off at the grooves 223 and 224 formed into it. From the cover 222 is also obtained a shortened end piece 226 of the casing 220′ by cutting off the cover 222 at the groove 224. This solution enables the manufacturing of two cases of various sizes using one mould. Preferably, the casing 220 is made of thermal insulation material, such as, for example, by casting of polyurethane, or to it is added a thermal insulation layer. Preferably, the cover 222 is also made of thermal insulation material. Preferably, the cover 222 or 222′ is installed to the lower surface of a separate element, such as, for example, a sauna bench, at the installation site of the device, and it is settled through the opening 232 of the frame part 130 within the casing 220, remaining in place due to the suitably dimensioned tightness between the lateral edges of the cover and the inner walls of the casing.

FIG. 6 shows yet another detail of the invention. In the longitudinal upper edges 227 of the casing 220 are formed longitudinal discharge grooves 228 which, when used in a sauna, guide the sweat trickling down from persons sitting on the benches away from the gap between the casing and its cover, preventing or reducing contamination of the inside of the casing.

1. An arrangement for serving beverage packagings (10), the arrangement comprising at least a storage chamber (120) for storing beverage packagings (10), a support element (210) with an upper surface, and a lifting unit (110) for lifting beverage packagings from the storage chamber, the lifting unit having an upper position and a lower position, in which the lifting unit (110) is adapted to be lifted and lowered between said upper and lower positions manually by the user of the arrangement (100), wherein the lifting unit (110) is arranged to lift a beverage packaging (10) from the storage chamber (120) onto said upper surface of the support element (210) when the lifting unit (110) is lifted from said lower position into said upper position, the lifting unit (110) having an inclined surface top (112) which is adapted to receive a beverage packaging (10) from said storage chamber (120) when the lifting unit (110) is in said lower position, wherein the beverage packaging (10) on said inclined surface top (112) is able to roll, driven by the inclination of said inclined surface top, onto the upper surface of the support element (210) when the lifting unit is in said upper position, characterised in that the arrangement (100) includes a front wall (111) extending downwards from the inclined surface top (112) of the lifting unit, the front wall being dimensioned to extend, when the lifting unit (110) is in the lifted-up position, at least partially in front of the beverage packagings (10) in the storage chamber (120), forming a retainer part to retain the beverage packagings (10) in place in the storage chamber (120), until the lifting unit (110) is lowered back down to the position receiving a beverage packaging.

2. An arrangement according to claim 1, characterised in that the arrangement includes a frame part (230) provided with quick fastening elements (231), by means of which a separate casing (220) containing a storage chamber (120) of the beverage packagings is to be fastened with the fastening parts (221) in the casing to the frame part (230) and is to be removed from there for cleaning the casing (220) as needed.

3. An arrangement according to claim 2, characterised in that the casing (220) surrounds the lifting unit (110) when the lifting unit is in its lower position.

4. An arrangement according to claim 2, characterised in that the casing (220) is provided in the area of its upper edge (227) with elongated discharge grooves (228), especially when used in a sauna, in order to guide the sweat and possible wash water trickling down from persons using the sauna away from the joint seam between the casing (220) and its cover (222).

5. An arrangement according to claim 2, characterised in that the casing (220) is made of thermal insulation material or is provided with thermal insulation material.

6. An arrangement according to claim 3, characterised in that the casing (220) is provided in the area of its upper edge (227) with elongated discharge grooves (228), especially when used in a sauna, in order to guide the sweat and possible wash water trickling down from persons using the sauna away from the joint seam between the casing (220) and its cover (222).

7. An arrangement according to claim 3, characterised in that the casing (220) is made of thermal insulation material or is provided with thermal insulation material.

8. An arrangement according to claim 4, characterised in that the casing (220) is made of thermal insulation material or is provided with thermal insulation material.
